(19) United States
(12) Patent Application Publication
(10) Pub. No.: US 2007/0181374 A1
(43) Pub. Date: Aug. 9, 2007

(54) Elevator shaft

(75) Inventor: Wolfgang T. Mueller, Radolfzell (DE)

Correspondence Address: Lipsitz & McAllister, LLC, 755 MAIN STREET, MONROE, CT, 06468, US

(73) Assignee: ThyssenKrupp Elevator AG, Duesseldorf (DE)

(21) Appl. No.: 11/634,515

(22) Filed: Dec. 5, 2006

Related U.S. Application Data
(63) Continuation of application No. PCT/EP05/05830, filed on May 31, 2005.

(30) Foreign Application Priority Data
Jun. 7, 2004 (DE) 20 2004 009 022.8

(51) Int. Cl. B66B 9/00

(52) U.S. Cl. 187/249

(57) ABSTRACT

The invention relates to an elevator shaft having up to four parallel tracks of the same type, adapted for the operation of a plurality of self-propelled cars per track, and having at least one transfer arrangement for switching tracks and for allowing cars to park on an interim basis, to turn and to pass one another. In order to configure the elevator shaft such that a plurality of cars together can utilize one track in a quadrilateral shaft, it is proposed according to the invention that the elevator shaft has a quadrilateral cross-section of up to four segments each with an independent track, the segments each being disposed such that an axis laid out horizontally through the outwardly-located corner of the cars passes through the center of an imaginary circle which likewise runs through the outer corners of the cars, this center simultaneously forming the center point of the elevator shaft and of the transfer arrangements which have been inserted.

This application is a continuation of international application number PCT/EP2005/005830 filed on May 31, 2005.

The present disclosure relates to the subject matter disclosed in international application number PCT/EP2005/005830 of May 31, 2005 and German application number 20 2004 009 022.8 of Jun. 7, 2004, which are incorporated herein by reference in their entirety and for all purposes.

### BACKGROUND OF THE INVENTION

The invention relates to an elevator shaft having up to four parallel tracks of the same type, adapted for the operation of a plurality of self-propelled cars per track, and having at least one transfer arrangement for switching tracks and allowing cars to park on an interim basis, to turn and to pass one another.

Vertical transportation in buildings nowadays takes place substantially using cable-operated or hydraulic elevators. The particular construction requires each car of an elevator to have its own, dedicated shaft. This means that it is not possible for a plurality of cars to use one track of the shaft at the same time. In the case of high buildings, up to 30% of the closed-in space is thus required for the elevator shafts alone.

More cost-effective systems are ones in which, depending on the traffic volume, a plurality of cars utilize the same track in the elevator shaft. It is thus possible to increase the transporting capacity to a considerable extent, while using up less closed-in space, in comparison with conventional elevators.

Meanwhile, the first system in which two conventional counterweighted elevators share an elevator shaft has come onto the market. Shaft usage has thus virtually been doubled. This solution, however, has the disadvantage that it is not possible for each of the two cars to reach the final stop. In addition, the possibilities of using more than two cars per shaft are restricted by the cables and counterweights.

Better and more flexible shaft usage is achieved with self-propelled cars which are driven, for example, by means of a linear motor or friction drive. The solution described hereinbelow is based on such self-propelled cars in the elevator shaft.

In publications and patent specifications, a large number of solutions for the multiple usage of elevator shafts are described. These solutions usually provide for circulatory travel of the cars in at least two elevator shafts. Depending on the traffic volume, it is then possible to bring as many cars as desired into use. In addition, the traffic flow in the shaft moves just in one direction, as a result of which the technical configuration of the system as a whole is simplified and the risk of collision is reduced.

Such systems have not been used up until now since it has not been possible to find any cost-effective solution for the shaft system and, in particular, for transferring the self-propelled cars from one shaft into the other.

Utility Model DE 202 06 290 U1 describes a straightforward system. The solution described, however, requires a cylindrical shaft system. Even the cars have to be in the form of a part-cylinder. As a result, both the shaft doors and the car doors have to be round, which increases the production costs to a considerable extent. In addition, cars and shaft have to be realized as part-cylinders, which takes getting used to, at least as far as their actual usage is concerned.

It is an object of the present invention to configure an elevator shaft of the type mentioned in the introduction such that a plurality of elevator cars together can utilize one track in a quadrilateral shaft.

### SUMMARY OF THE INVENTION

This object is achieved by an elevator shaft having the features of Patent Claim 1. T

he advantages achieved by the invention consist, in particular, in that it is possible to realize in a cost-effective manner the principle of one track being utilized simultaneously by a plurality of cars in the nowadays customary design comprising shafts and cars which have corners. The invention allows an elevator shaft with just one track to be utilized by up to four self-propelled cars.

Up to four independent tracks can be inserted in parallel into a fully fitted-out elevator shaft.

In the case of the tracks being equipped correspondingly, the self-propelled cars can be used with a linear motor or a friction drive or in mixed operation.

Linking of the tracks is effected by a transfer arrangement, which can be positioned at any desired location in the shaft.

The multifunctional transfer arrangement allows the cars to be parked on an interim basis and to be switched from one track to the other. It is thus possible to meet an extremely wide variety of different requirements, e.g. the circulatory movement of cars, the ability of cars to pass one another or adaptation of the car frequency to the traffic volume.

Since the cars can move into the transfer arrangement from both sides, as is the case in a railway station, it is possible to achieve a particularly high level of disaster prevention, especially if a building is wholly or partially destroyed in the middle by an explosion.

In order to achieve this level of disaster prevention, transfer arrangements are positioned at regular intervals in a shaft with at least two tracks. If a building, including the shaft, is destroyed in the middle, the control system puts the affected portion out of service. Independent circulatory movement can maintain service in the shaft in those regions of the building which are located below and above the affected portion.

### EXEMPLARY EMBODIMENTS

The aim of the invention is to provide a cost-effective traffic system for transporting people in buildings which meets a very wide variety of different requirements and nevertheless can be standardized to a large extent.

Two exemplary embodiments are described hereinbelow. Both perform substantially the same functions.

The traffic system comprises a multiple shaft and a transfer arrangement. The fully fitted-out, quadrilateral multiple shaft is subdivided into four equal segments. Each segment contains one track for simultaneous operation of a plurality of self-propelled cars. The tracks and cars may be equipped for different types of drive, for example for a friction drive or a linear-motor drive. Mixed operation is also possible.

The transfer arrangement forms the start-off or end station of the system as a whole. It is also possible for the transfer arrangement to be inserted at any desired location in the shaft as an intermediate station.

The transfer arrangement acts as a multifunctional transport hub. It allows the cars to switch track, to change direction, to pass one another and to park on an interim basis. It is also possible, however, for the cars, remaining on the same track, simply to pass through the transfer arrangements. When the transfer arrangements are used as an intermediate station, the traffic in higher buildings can be subdivided into larger portions. It is thus possible, in the event of accidents in the building, for the affected portion to be brought to a standstill, without this having any adverse effect on the portions located above or below.

Two selected exemplary embodiments of the invention are described hereinbelow and illustrated in the drawings.

### BRIEF DESCRIPTION OF THE DRAWINGS

FIG. 1: shows a horizontal section through a quadrilateral multiple shaft with corner access and four parallel tracks;

FIG. 2: shows a horizontal section through a quadrilateral multiple shaft with corner access and two parallel tracks;

FIG. 3: shows a horizontal section through a quadrilateral multiple shaft with corner access and one track;

FIG. 4: shows a plan view of a transfer arrangement which is formed as a spider and has four segments for accommodating four square cars;

FIG. 5: shows a plan view of a transfer arrangement which is formed as a semicircle and has a segment, which can be pivoted to the right or left, for accommodating one square car;

FIG. 6: shows a horizontal section through a quadrilateral multiple shaft with four parallel tracks, configured for rectangular cars with lateral sliding doors;

FIG. 7: shows a plan view of a transfer arrangement which is designed as a swastika-formed spider and has four segments for accommodating a rectangular car with lateral sliding doors.

### DETAILED DESCRIPTION OF THE INVENTION

### Example of Use 1

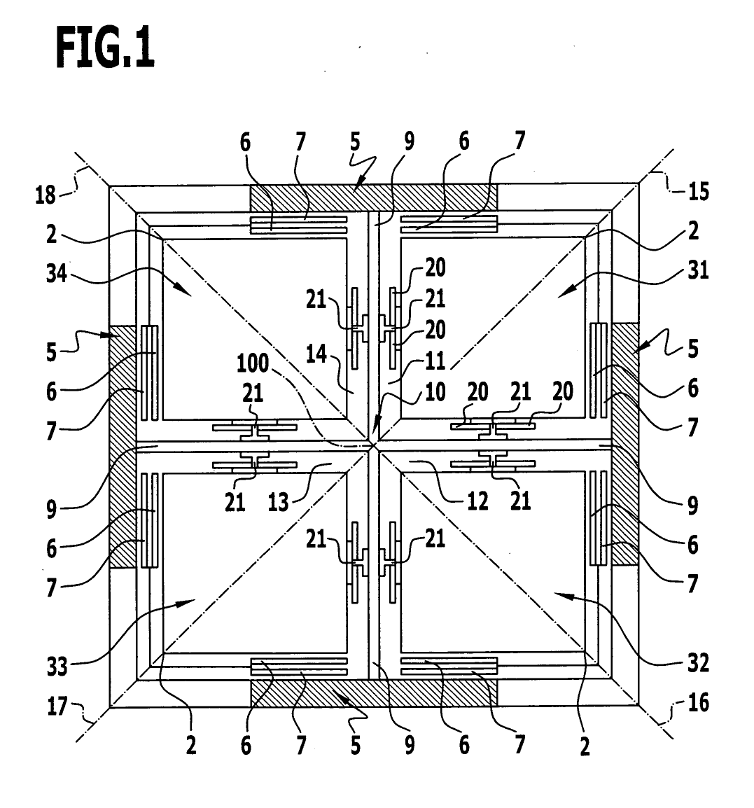

FIG. 1 shows, as a first Example of use 1, a shaft 5 of square cross-section. It is subdivided into four equal segments 11, 12, 13, 14 by a right-angled cross 10. Each of the segments 11, 12, 13, 14 is equipped with a track. For this purpose, the legs 9 of the cross 10 are provided with vertical guide rails 21 on each side. The guide rails 21 for one segment are positioned at right angles to one another. In the example, they are configured with a dedicated friction drive for operating self-propelled cars 31, 32, 33, 34. Rollers 20 are pressed onto the rails 21 in each case and, for this purpose, are equipped with a regulated drive. Power is supplied via vertical conductor rails (not depicted). The four tracks are disposed such that an axis 15, 16, 17, 18 laid out horizontally through the outwardly-located corner 2 of the cars 31, 32, 33 34 passes through the center 100 of an imaginary circle which likewise runs through the outer corners 2 of the cars 31, 32, 33, 34, this center 100 simultaneously forming the center point of the elevator shaft 5 and of the transfer arrangements which have been inserted.

The cars 31, 32, 33, 34 and the four shaft segments 11, 12, 13, 14 each have corner access. For this purpose, the car doors 6 and shaft doors 7 run towards one another at right angles and meet at the axes 15, 16, 17, 18.

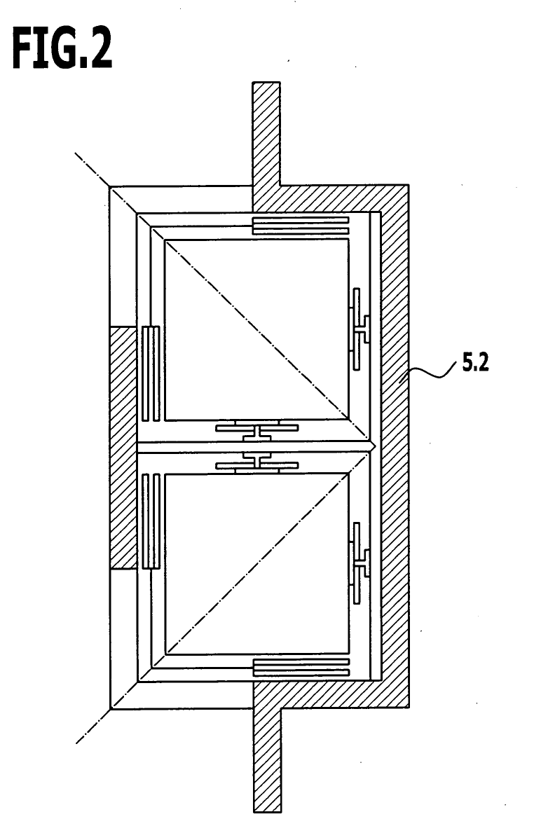

FIG. 2 shows the shaft 5, which is illustrated in FIG. 1, as a part-shaft 5.2 of identical construction, but with just two segments and/or tracks arranged one beside the other.

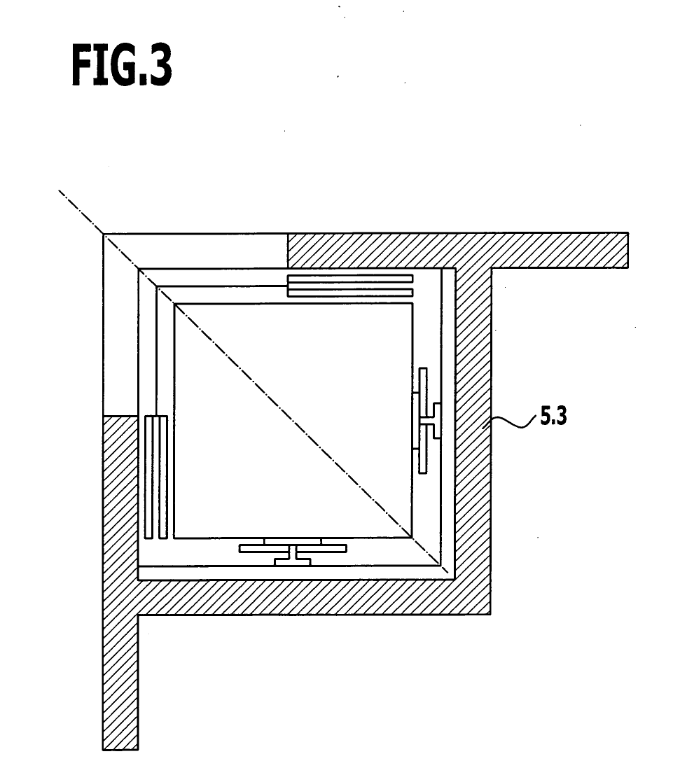

For small applications, FIG. 3 shows the shaft 5, which is illustrated in FIG. 1, as a part-shaft 5.3 of identical construction, albeit, with just one segment and/or one track.

### Transfer Arrangement

The transfer arrangement serves, in particular, to switch a car from one shaft into another. For this purpose, the car moves into a rotatably mounted spider, which has the height of a car, from the top or bottom. The transfer operation is carried out by a horizontal rotary movement with the car to the right or left. If the rotatable segment with the car is positioned precisely above the desired segment in the shaft, the spider is locked electrically and mechanically. The car can then continue its journey upward or downward. The transmission of power, and possibly the transfer of information, from the stationary shaft to the spider takes place, for example, using slipring contacts or flexible lines. The transfer of information can take place, for example, in a wireless manner by way of a transmitting and receiving device.

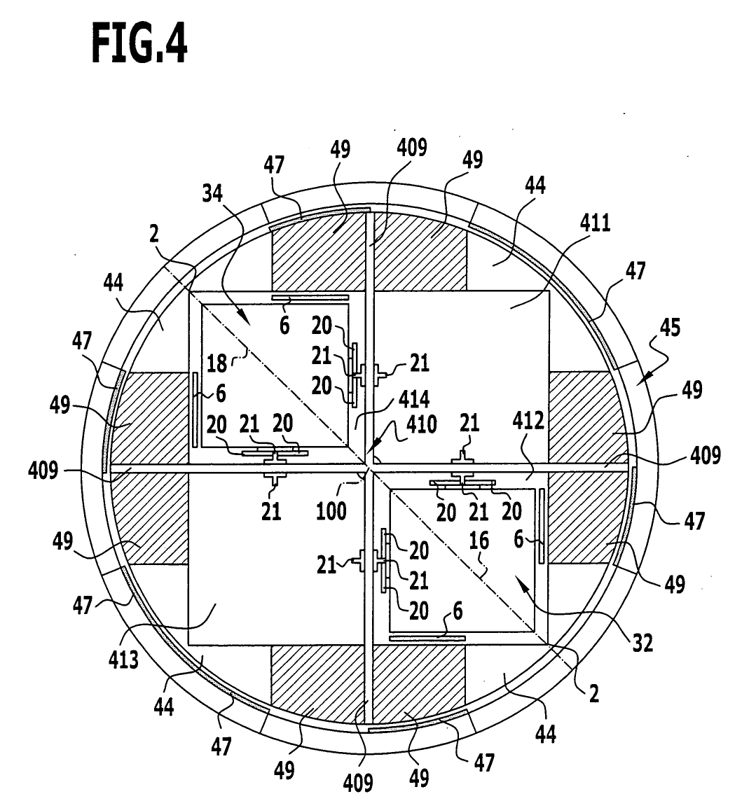

FIG. 4 shows the plan view of a transfer arrangement which is formed as a spider 410 and has four equal segments 411, 412, 413, 414 for accommodating four square cars with corner access.

The transfer arrangement is round, has a height equal to one storey of the building and is configured to rotate to the right and left by way of a dedicated drive. It is enclosed by a fixed circular shaft wall 45. For each of the segments 411, 413, 414, 415, round, centrally opening sliding doors 47 with a dedicated drive are incorporated into the shaft wall 45. The axis of the spider 410 is mounted on the center point of the shaft cross 10. Each of the segments 411, 412, 413, 414 of the spider 410 is equipped with a track. For this purpose, the legs 409 of the spider 410 are provided with vertical guide rails 21 on each side. The diameter of the spider 410 corresponds to the distance of the axis 16, 18 between the outer corners of the mutually opposite cars, e.g. 32, 34. The segments 411, 412, 413, 414 of the spider 410 between the legs 409 are delimited in relation to the shaft wall 45 by rotating door sills 44. Room-height coverings 49 are fitted to the right and left of these door sills.

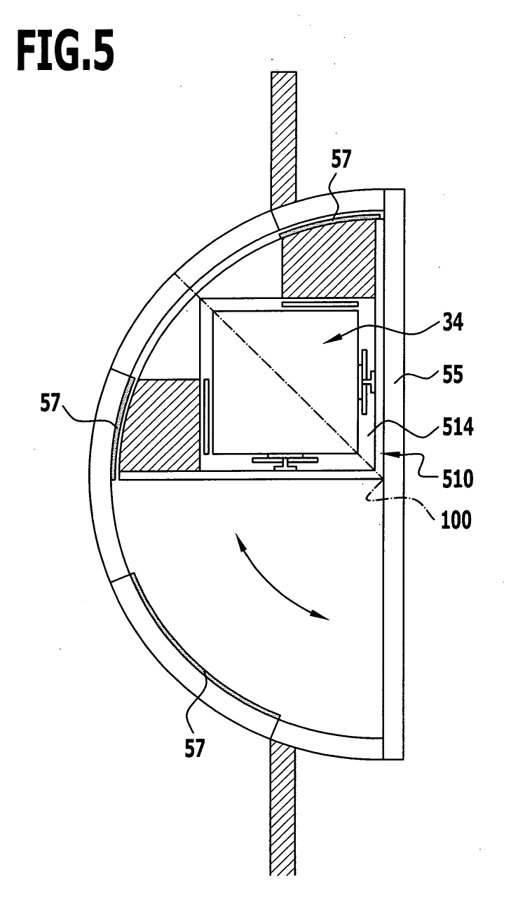

FIG. 5 shows the plan view of a reduced-size transfer arrangement in the form of a spider 510 with a car 34 which can be pivoted to the right or left. The shaft wall 55 is of semicircular configuration, and sliding doors 57 are incorporated into the shaft wall 55. The spider 510, which is illustrated in FIG. 5, is provided only in quarter form and defines a segment 514. Otherwise, the construction is identical to that in FIG. 4.

### Possible Combinations

The four-section shaft in FIG. 1, the two-section shaft in FIG. 2 and the single-section shaft in FIG. 3 may be combined with the spiders in FIGS. 4 and 5 to provide a wide number of different variants.

If the four-section shaft of FIG. 1 is combined with the complete spider in FIG. 4, it is possible, for example, for in each case two of the four shafts to provide for independent circulatory movement of cars. In another variant, two shafts are used for the main direction of traffic and the third shaft is used for returning the cars. The fourth shaft serves as a reserve.

A reduced-scale solution is provided by the two-section shaft in FIG. 2 together with the half-spider in FIG. 5. It is thus possible to provide for a complete circulatory movement with a plurality of cars.

The smallest-scale solution is achieved by combining the single shaft in FIG. 3 with the spider in FIG. 4. This combination allows up to four cars to move upward, one behind the other, along the shaft into an upper spider. The direction is then changed and the four cars can move downward again, in reverse order, into a lower spider.

It is also possible, in principle, to operate the single shaft together with just one car, with or without counterweighting.

### Example of Use 2

The traditional elevator structure is generally based on square or rectangular cars equipped with laterally or centrally opening doors. Cost-effective components are commercially available for this solution. The linear drive offers good future prospects as a drive variant for self-propelled cars. Account has thus taken of these requirements in the configuration of Example of use 2.

Otherwise, all functions and application variants of Examples of use 1 and 2 are however identical, so that only the differences in configuration will be discussed hereinbelow.

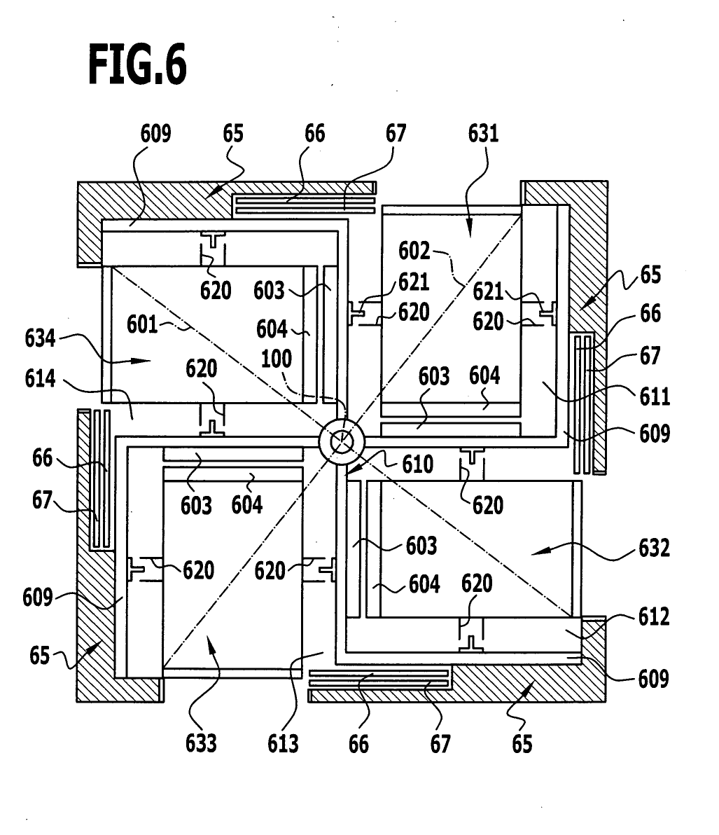

Instead of a square shaft, FIG. 6 shows a rectangular shaft 65, which is subdivided into four rectangular segments 611, 612, 613, 614 by a swastika 610. Each of the segments 611, 612, 613, 614 is equipped with a track. The parallel legs 609 of the shaft cross 610 are provided with vertical guide rails 621 on the inside per segment. The leg therebetween carries the active or the passive part 603 of a linear motor. The counterpart 604 is seated on the respective car 631, 632, 633, 634.

The four segments 611, 612, 613, 614, each with an independent track, are once again disposed such that an axis 601, 602 located horizontally through the outwardly-located corner of the cars passes through the center 100 of an imaginary circle which likewise runs through the outer corners of the cars 631, 632, 633, 634, this center 100 simultaneously forming the center point of the swastika 610 and of the transfer arrangements which have been inserted.

The cars 631, 632, 633, 634 and the shaft 65 are each equipped with laterally opening sliding doors 67, 66.

The four-section shaft 65 in FIG. 6, as in Example of use 1, may likewise be realized with two segments or just with one segment.

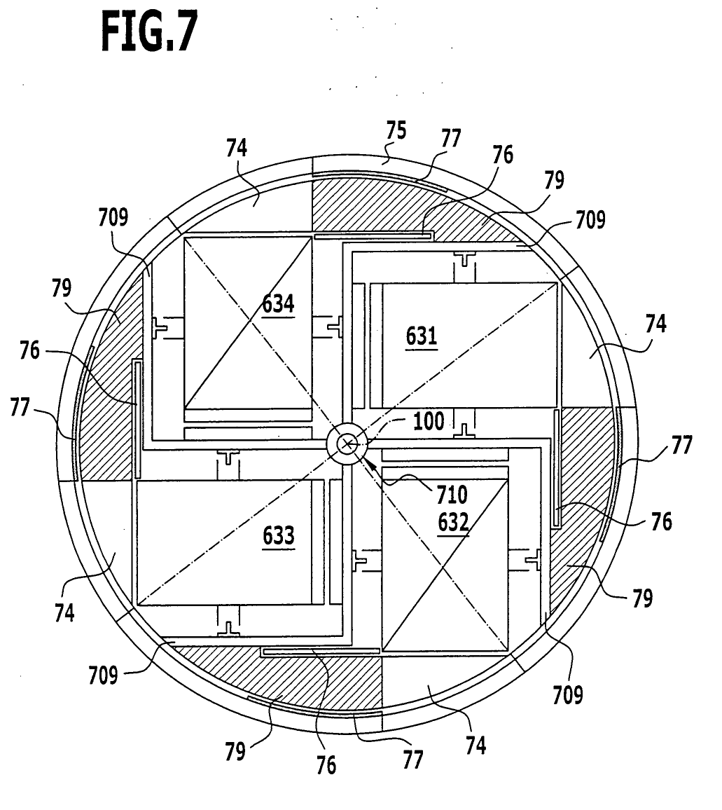

FIG. 7 illustrates a transfer arrangement with a spider in the form of a swastika 710, having legs 709, and with rectangular cars 631, 632, 633, 634 and laterally opening sliding doors 76. The latter expose door sills 74 which are disposed laterally alongside coverings 79. In addition, like the shaft 65, the spider 710 is equipped for the linear drive. Round, single-leaf shaft doors 77 each have a dedicated drive.

In the economy version, the transfer arrangement in FIG. 7 may also be realized as a semicircle with a pivotable segment for accommodating one car.

1. Elevator shaft having up to four parallel tracks of the same type, adapted for the operation of a plurality of self-propelled cars per track, and having at least one transfer arrangement for switching tracks and for allowing cars to park on an interim basis, to turn and to pass one another, wherein the elevator shaft has a quadrilateral cross-section having up to four segments each with an independent track, the segments each being disposed such that an axis laid out horizontally through the outwardly-located corner of the cars passes through the center of an imaginary circle which likewise runs through the outer corners of the cars, this center simultaneously forming the center point of the elevator shaft and of the transfer arrangements which have been inserted.

2. Elevator shaft according to claim 1, wherein the elevator shaft is configured as a part-shaft with one, two or three segments.

3. Elevator shaft according to claim 1, wherein the transfer arrangement is formed as a right-angled spider with up to four segments for accommodating a maximum of four cars.

4. Elevator shaft according to claim 3, wherein the transfer arrangement is inserted in the shaft at the start and at the end of the shaft or at any desired stopping point.

5. Elevator shaft according to claim 1, wherein access to the shaft and car takes place via a corner and, correspondingly the door leaves of the shaft and car doors meet at right angles.

6. Elevator shaft according to claim 3, wherein the spider is configured as a swastika.

7. Elevator shaft according to claim 6, wherein access to the car takes place via the outwardly-located end face and via upright elevator doors.

8. Elevator shaft according to claim 1, wherein the shaft doors of the transfer arrangement are equipped with an independent drive.

9. Elevator shaft according to claim 1, wherein the tracks in the shaft are equipped for operation of cars with a linear motor.

10. Elevator shaft according to claim 1, wherein the tracks in the shaft are equipped for operation of cars with a friction drive.

11. Elevator shaft according to claim 3, wherein the segments of the spider are open at the top and bottom, and the cars can move into the segment from the top or bottom or can also travel through the segment.

12. Elevator shaft according to claim 3, wherein the spider is equipped with a locking arrangement and a signaling arrangement, these becoming active when, following a rotary movement, the segments are positioned exactly above the tracks again.

13. Elevator shaft according to claim 1, wherein the elevator shaft has a rectangular base and the transfer arrangement has a circular base.

14. Elevator shaft according to claim 1, wherein a plurality of transfer arrangements can be positioned one above the other.

15. Elevator shaft according to claim 1, wherein the tracks in the shaft, including the transfer arrangement, are equipped for the mixed operation of cars with a friction drive and a linear motor.

16. Elevator shaft according to claim 3, wherein the transfer arrangement is formed as a semicircle with a segment, which pivots to the right and left, for accommodating no more than one car.
